(19) United States
(12) Patent Application Publication
(10) Pub. No.: US 2014/0095418 A1
(43) Pub. Date: Apr. 3, 2014

(54) FRAMEWORK FOR QUANTITATIVE ANALYSIS OF A COMMUNICATION CORPUS

(71) Applicants: Andrew J. Scholand, Albuquerque, NM (US); James W. Pennebaker, Austin, TX (US); Yla R. Tausczik, Austin, TX (US)

(72) Inventors: Andrew J. Scholand, Albuquerque, NM (US); James W. Pennebaker, Austin, TX (US); Yla R. Tausczik, Austin, TX (US)

(21) Appl. No.: 12/408,856

(22) Filed: Mar. 23, 2009

(51) Int. Cl. G06N 5/02; G06T 11/20; G06Q 99/00; G06F 17/27

(52) U.S. Cl. 706/46; 704/9; 345/440

(57) ABSTRACT

A quantitative technique for social network analysis is described. The technique uses a communication corpus embodying one or more conversations between participants in the one or more conversations. One or more conversation links are generated for association with conversation statements within the communication corpus. Each of the conversation links pairs a source participant who expressed a given conversation statement with a recipient participant whom the given conversation statement is deemed to have been directed. The conversation statements are analyzed to generate conversation link metrics that quantitatively categorize the conversation statements based on psychological, sociological, or emotional indicia. The conversation link metrics are input into a graph processing algorithm and a graphical representation of psychological, sociological, or emotional relationships between the participants is rendered.

### STATEMENT REGARDING FEDERALLY SPONSORED RESEARCH

This invention was developed with Government support under Contract No. DE-AC04-94AL85000 between Sandia Corporation and the U.S. Department of Energy. The U.S. Government has certain rights in this invention.

### TECHNICAL FIELD

This disclosure relates generally to social network analysis, and in particular but not exclusively, relates to quantitative analysis of social networks using group communications.

### BACKGROUND INFORMATION

A social network graph is structure made up of nodes, which represent individuals within a social environment, tied together by one or more specific types of interdependencies. Such interdependencies may include hobbies, ideas, values, interests, dislikes, conflicts, or otherwise. In its simplest form, a social network graph is a graphical representation of relevant ties between the nodes or individuals being studied.

A social network graph is a tool used in social network analysis to study and understand a complex set of relationships between members of a social system. Social network analysis is different from traditional social scientific studies, which focus on the attributes of the individuals being studied. In contrast, social network analysis is primarily concerned with the relationships and ties between the individuals being studied and only secondarily concerned with their specific attributes. This approach is useful for characterizing many real-world phenomena, such as, explaining how organizations interact with each other, characterizing the many informal connections that link executives together, as well as the associations between individual employees within the same or different companies. For example, an individual's power within an organization may be explained by the degree to which the individual is at the center of many relationships rather than the individual's actual job title. Such individuals may be referred to as “influentials.” Social network analysis may be used to identify influentials within a social network and target those individuals for selective solicitation, promotion, termination, coercion, or otherwise.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 is a flow chart illustrating a process for quantitative analysis of a communication corpus, in accordance with an embodiment of the invention.

FIG. 2 illustrates an example communication corpus embodied as a record of a group chat forum, in accordance with an embodiment of the invention.

FIG. 3 illustrates a technique of segmenting a communication corpus into discrete conversations, in accordance with an embodiment of the invention.

FIG. 4 illustrates a social network matrix identifying conversation links between participants in one or more conversations, in accordance with an embodiment of the invention.

FIG. 5 illustrates a social network graph having conversation statements associated with conversation links between participants, in accordance with an embodiment of the invention.

FIG. 6 illustrates adjacency matrixes populated with conversation link metrics, in accordance with an embodiment of the invention.

FIG. 7 illustrates a social network graph having conversation link metrics associated with conversation links between participants, in accordance with an embodiment of the invention.

FIG. 8 illustrates a personal pronoun network graph, in accordance with an embodiment of the invention.

FIG. 9 is a graph illustrating a respect/status hierarchy between participants in conversations, in accordance with an embodiment of the invention.

FIG. 10 is a graph illustrating discrepancies between individual and group defined status, in accordance with an embodiment of the invention.

FIG. 11 is a block diagram illustrating a demonstrative processing system to store and execute embodiments of the invention thereon.

### DETAILED DESCRIPTION

Embodiments of a system and method for quantitative analysis of a communication corpus are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The present disclosure is an application of the theoretical science of social network analysis combined with psycholinguistic analysis to a structured framework for analyzing conversations and obtaining quantitative measurements of the relations between participants to the conversations. Based on a communication corpus including one or more conversation records, the framework is capable of measuring co-worker attitudes toward one another, measuring perceptual biases of competence across a team, measuring how information flows between team members, and identifying particular social structure known to potentially lead to team conflict. This framework can serve organization and social structure analysis purposes that have multiple uses. For example, understanding the social structure of a group of friends or co-workers can be used to identify influential individuals with the most social status, referred to as “influentials,” to whom products, ideas, or allegiances are aggressively marketed or solicited. Additionally, the framework can quantitatively identify those individuals that are least committed to or integrated in a group, the sources or sinks of technical advice within a group, those providing the most social support, etc.

Traditional techniques for obtaining similar information include questionnaires and opinion polls. However, these techniques are often susceptible to ill conceived questions by the interviewer and conscious manipulation by the interviewee that can undermine the veracity of the responses. The framework disclosed herein can extract these quantitative measurements from collections of everyday communications between members of a group, such emails or public chat forums. Since the framework operates upon a communication corpus collected from everyday sources, participants in the conversations have less opportunity to consciously circumvent or manipulate the outcomes.

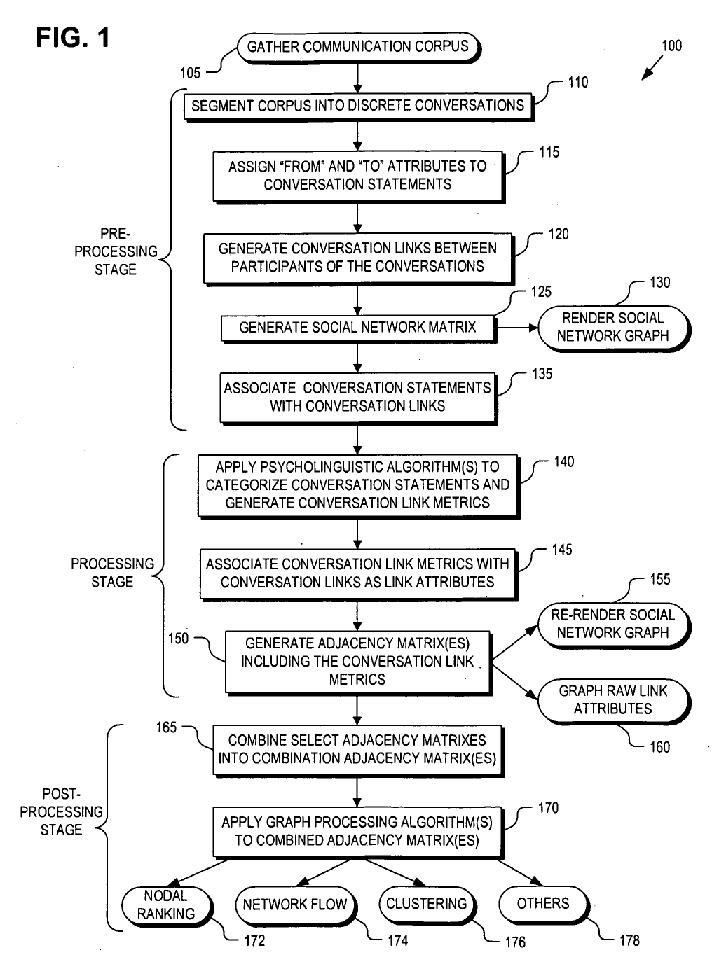

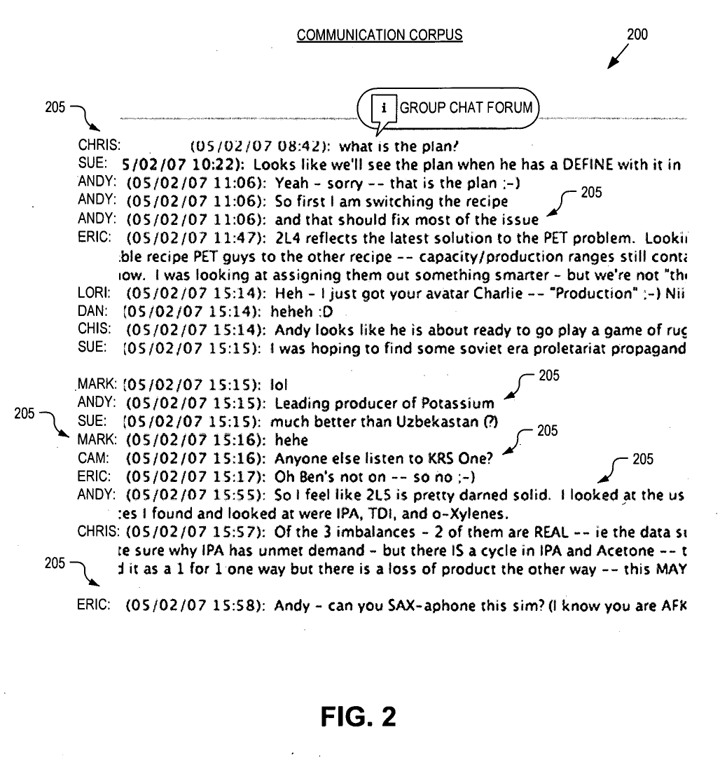

FIG. 1 is a flow chart illustrating a process 100 for quantitative analysis of a communication corpus, in accordance with an embodiment of the invention. Process 100 is described in connection with FIGS. 2-10. The order in which some or all of the process blocks appear in process 100 should not be deemed limiting. Rather, one of ordinary skill in the art having the benefit of the present disclosure will understand that some of the process blocks may be executed in a variety of orders not illustrated.

In a process block 105, a communication corpus is gathered. The communication corpus is a record of one or more conversations between members of a group under study. The members are also participants in the conversations embodied within the communication corpus. Conversations are made up of statements expressed by source participants to one or more recipient participants, and in some scenarios a statement may be expressed to which no one responds, which may be deemed a statement to oneself for purposes of subsequent processing. The communication corpus may be gathered from many different sources, such as email archives, transcripts of meetings, corporate minutes, courtroom stenographer records, deposition records, congressional records, group chat forums (e.g., Internet Relay Chat), online blogs, or otherwise.

FIG. 2 illustrates an excerpt from an example communication corpus 200 gathered from records of a group chat forum. Corpus 200 includes conversation statements 205 tagged with usernames and timestamps. Only a portion of the conversation statements are labeled (as well as other elements in the drawings that follow) so not to clutter the drawing.

In general, various techniques may be used to allocate conversation statements by a given participant (from) to an intended recipient (to). In some cases the link between source and recipient is explicit. For example, where a corpus includes emails, identification of the source and recipient participants of a conversation statement (e.g., the body of the email) may be extracted from the “FROM” and “TO” email address header fields. In other cases, the link must be inferred.

One technique for determining recipient participants looks at time intervals between communications statements 205 to cluster them into conversations that occur synchronously, based on the length of time between consecutive conversation statements 205. Statements that are separated by more than a threshold period (e.g., 5 minute threshold), are assumed to belong to different conversations within corpus 200. The time-interval technique assumes that statements made within a discrete conversation are addressed to all participants in the discrete conversation and only those participants, excluding the source. An exception to this rule is where a conversation is made up of only one participant. In scenarios where a conversation is made up of only one participant because no one responded to a conversation statement, the source participant is deemed to being talking to himself and therefore tagged as both the source and recipient participant of his own conversation statement.

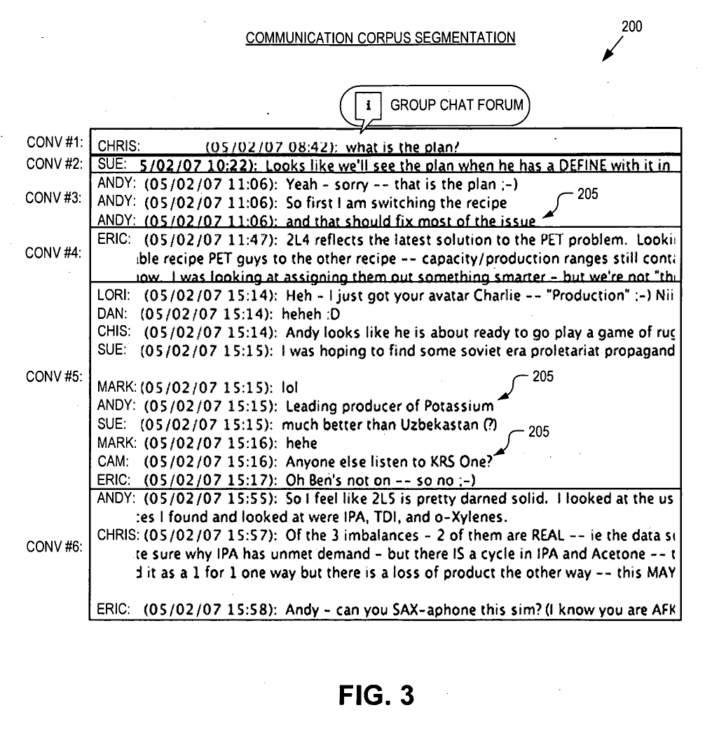

In a process block 110, corpus 200is segmented into discrete conversations (e.g., CONV #1, CONV #2, CONV #3, CONV #4, CONV#5, and CONV #6), as illustrated in FIG. 3. As discussed, segmenting a corpus into discrete conversations can be useful to determine who are the recipient participants to a given conversation statement. While the source participant may be extracted from the username associated with the conversation statement 205, an identification of the intended recipient participant(s) is inferred using the time-interval technique. Applying the one participant exception outlined above to corpus 200, CHRIS is both the source and recipient of his statement in conversation CONV #1 and SUE is both the source and recipient to her statement in conversation CONV #2.

In a process block 115, “FROM” and “TO” attributes are assigned to each conversation statement 205, using one of the approaches discussed above. Once the “FROM” and “TO” attributes are assigned, the attributes are used to generate conversation links between the participants to each of the conversations. The conversation links are dyadic links linking a single source participant to a single recipient participant. If a conversation statement 205 is expressed to multiple recipient participants, then a different conversation link is created for each FROM-TO pairing for the conversation statement. In one embodiment, conversation links are unidirectional. In this unidirectional embodiment, for conversation statements between two participants A and B, a first communication link is created for all statements from participant A to participant B and a second, separate communication link is created for all statements from participant B to participant A.

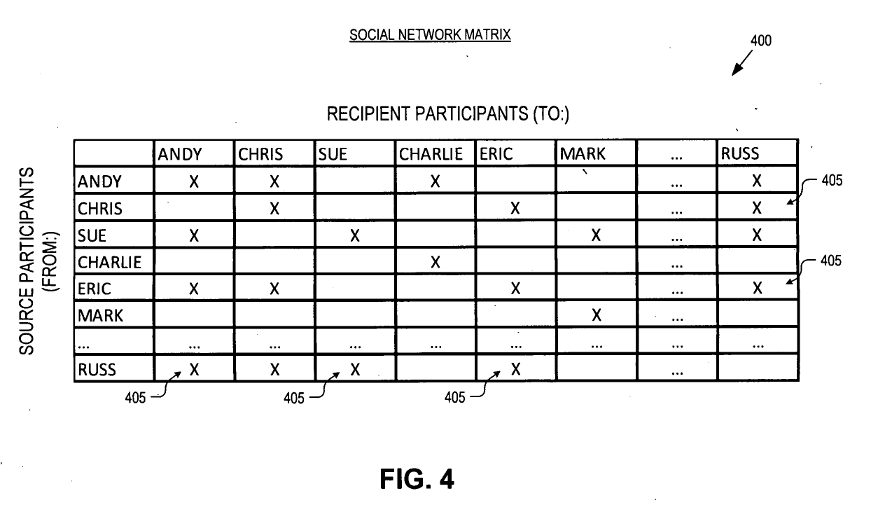

In a process block 125, a social network matrix is generated and populated with indications of conversation links between the participants to all the conversations embedded within corpus 200. FIG. 4 illustrates a social network matrix 400, in accordance with an embodiment of the invention. The illustrated embodiment of social network matrix 400 includes the participants to all the conversations listed as source participants down the left most column and listed as recipient participants along the top most row. An “X” within interior cells represents a dyadic link or conversation link 405 between the associated source and recipient participants, as determined from the attributes assigned in process block 115.

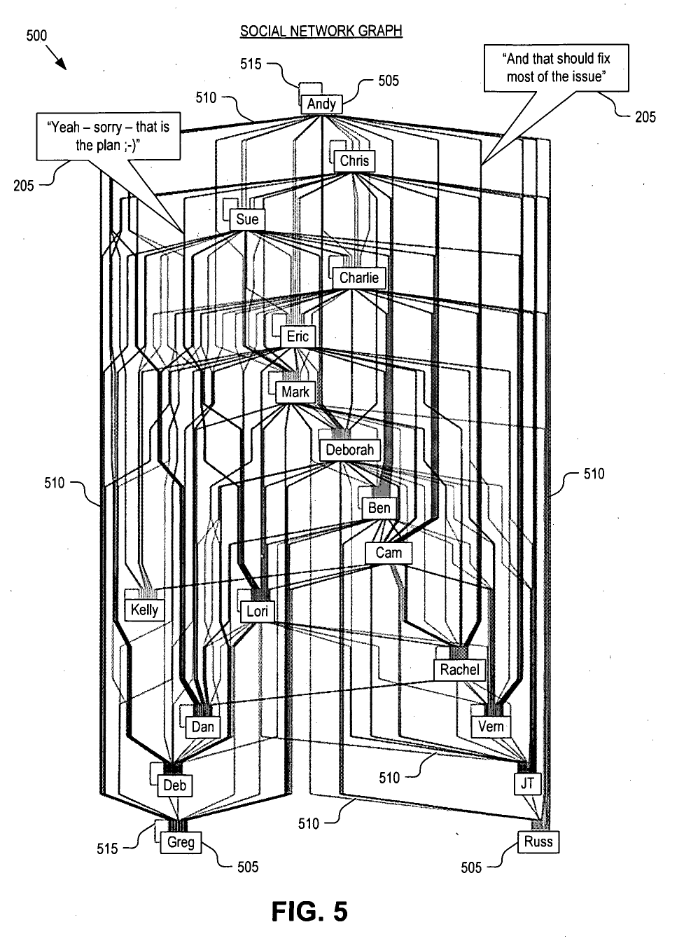

In a process block 130, a social network matrix may be graphically represented as a social network graph. FIG. 5 illustrates a social network graph 500, in accordance with an embodiment of the invention. The illustrated embodiment of social network graph 500 includes nodes 505, each representing a conversation participant, linked together by arcs 510, each representing a conversation link 405. Some of the nodes 505 also include loop arcs 515 initiating and terminating on the same node 505. Loop arcs 515 represent a communication link 405 where the source participant was deemed to be talking to himself, since his conversation statement was not responded to.

In a process block 135, conversation statements 205 are associated with each of their conversation links 405. This association may be achieved by embedding the corresponding conversation statement 205 into each cell of social network matrix 400 marked with an “X,” by embedding pointers to the corresponding conversation statements 205 within cells marked with an “X,” or other efficient programming techniques. Graphically, this association is represented in FIG. 5 with callouts of the conversation statements 205 pointing to their corresponding arcs 505. As discussed above, in one embodiment, all statements having the same directional sensitive FROM-TO attributes are associated with the same arc 505.

Once the social network matrix 400 has been generated and conversation statements 205 associated with their conversation links 405, the pre-processing stage is complete. Next, the processing stage identifies key linguistic markers or indicia of various psychological, sociological, or emotional states of the speaker (source participant) in relation to the associated recipients.

In a process block 140, conversation statements 205 are analyzed to generate conversation link metrics that quantitatively categorize conversation statements 205 based on psychological, sociological, or emotional indicia within the statements themselves. In one embodiment, each conversation statement 205 is input into a psycholinguistic algorithm to generate the conversation link metrics. For example, this processing may be accomplished using the Linguistic Inquiry and Word Count (“LIWC”) software developed by James Pennebaker, as described in Chung, C. K., & Pennebaker, J. W., “The Psychological Functions of Function Words” In K. Fiedler (Ed.), Social Communication (pp. 343-359), New York: Psychology Press (2007), hereby incorporated by reference. The LIWC software is available from LIWC Inc. and available for download at http://www.liwc.net. The LIWC software analyzes each conversation statement 205 and generates deterministic numerical values for various psychological, sociological, or emotional categories. For example, one indicator of respect towards a recipient of a statement is the number of personal pronouns the speaker uses. Accordingly, one category analyzed by the LIWC software is to generate personal pronoun counts and/or ratios for each conversation statement 205. For example, ratio-based metrics for personal pronoun usage may include the ratio of personal pronouns to total number of words in the unit of assessment (either individual statement or all statements lumped together). Of course, the term “ratio” is defined herein to include the use of percentages, which is simply just another way to express a ratio. Conversation statements 205 may be analyzed for linguistic indicia of other psychological, sociological, or emotional categories, such as anger, fear, anxiety, and a plethora of other categories.

Conversation statements 205 associated with a given conversation link 405 can be analyzed in at least two different manners. In one embodiment, all conversation statements 205 associated with a particular conversation link 405 can be aggregated into one document and the psycholinguistic algorithm applied to the document as a whole to generate conversation link metrics for that particular conversation link 405. In an alternative embodiment, the ‘n’ different conversation statements 205 associated with a given conversation link 405 can be analyzed by the psycholinguistic algorithm independently to generate ‘n’ different sets of conversation link metrics, which are subsequently averaged (weighted or unweighted average) to generate a final set of conversation link metrics for the particular conversation link 405. The averaging technique may provide improved results when the contribution between participants in the conversation (measured by total word count on each conversation link 405) is substantially uneven across the participants.

Of course, other psycholinguistic algorithms, including latent semantic analysis (“LSA”) algorithms may be used. LSA generates statistical values indicating the degree of correlation between an expressed conversation statement 205 and a particular psychological, sociological, or emotional category.

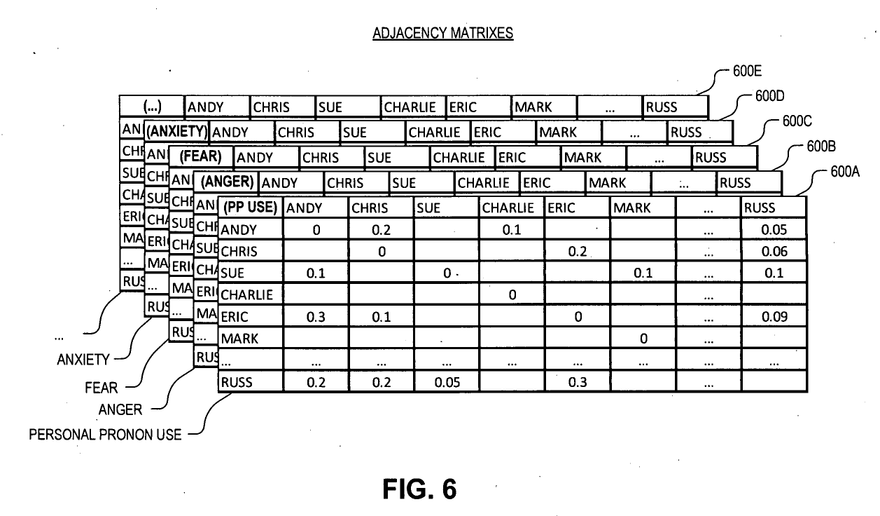

In a process block 145, the conversation link metrics are associated with corresponding conversation links 405. Once associated, the conversation link metrics may also be referred to as link attributes, since they describe characteristics or attributes of the dyadic links between the two participants. In a processing block 150, adjacency matrixes are generated and populated with the link attributes. FIG. 6 illustrates several adjacency matrixes 600A-E, in accordance with embodiments of the invention. Each adjacency matrix 600 includes a link attribute generated by the psycholinguistic algorithm for a specified psychological, sociological, or emotional category. For example, adjacency matrix 600A lists the numerical ratio values for personal pronoun use, which is associated with respect, adjacency matrix 600B lists the numerical values for measuring anger indicia, adjacency matrix 600C lists the numerical values for measuring of fear indicia, adjacency matrix 600D lists the numerical values for measuring of anxiety indicia, and adjacency matrix 600E represents any number of other categories. Although FIG. 6 illustrates five adjacency matrixes 600, it should be appreciated that more or less adjacency matrixes may be generated for any number of psychological, sociological, or emotional categories.

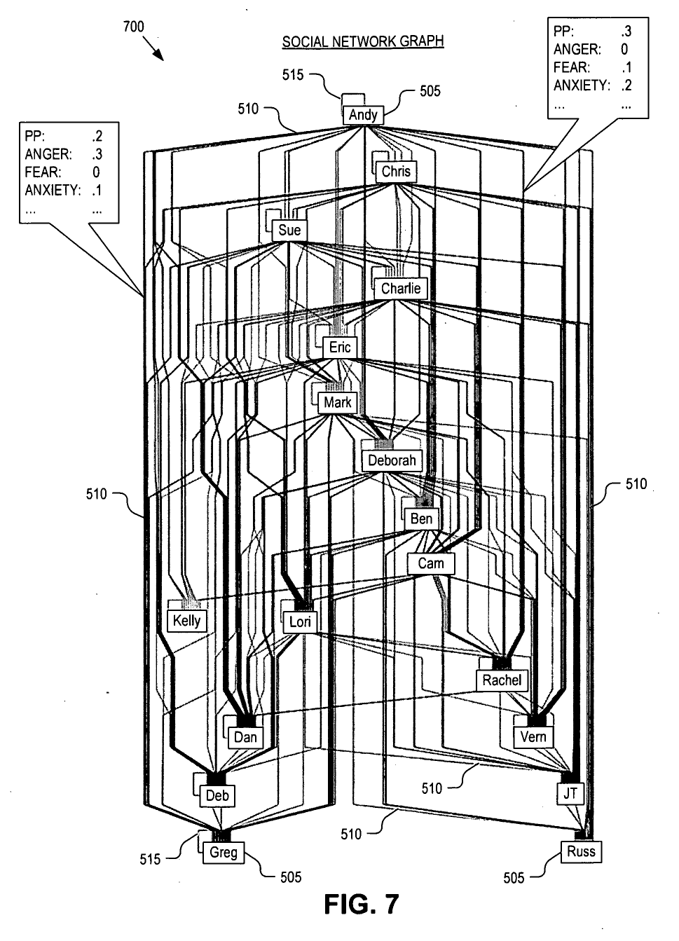

In a process block 155, social network graph 500 is re-rendered to combine the link attributes populated into adjacency matrixes 600 with the link indications of social network matrix 500. FIG. 7 illustrates social network graph 700 having conversation link metrics associated with arcs 510, in accordance with an embodiment of the invention.

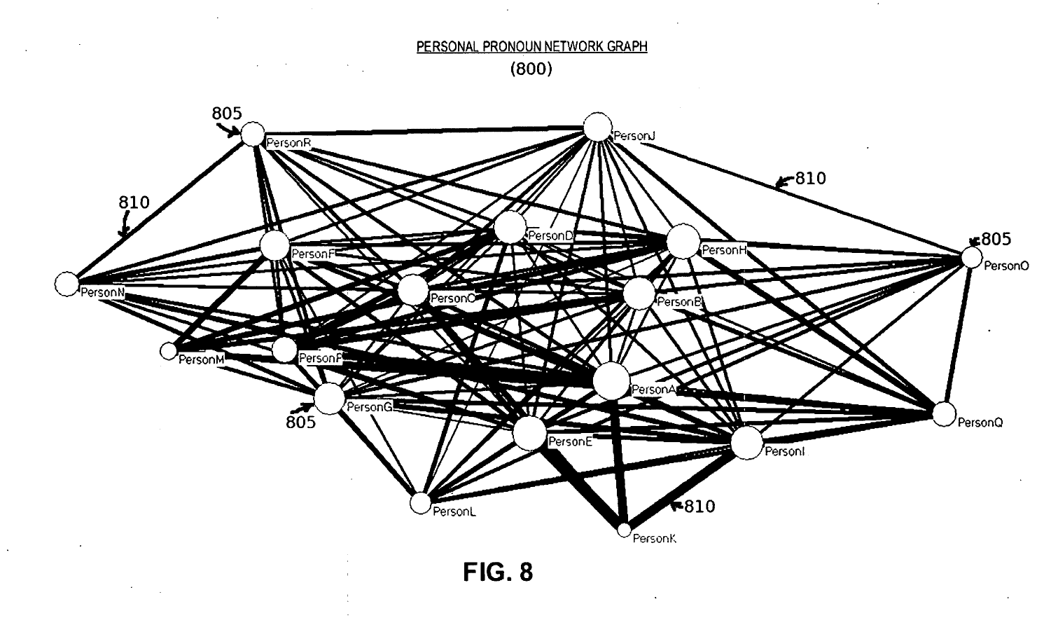

The raw data embedded within the link attributes may also be graphically illustrated. For example, FIG. 8 includes a personal pronoun network graph 800 illustrating information similar to that contained within the personal pronoun attribute of adjacency matrix 600A. Personal pronoun network graph 800 includes nodes 805 connected by arcs 810. Each node 805 represents a participant while each arc 810 represents a statement of respect between the participants. The size of the particular node 805 represents the total amount of group deference or respect (in the form of the number of personal pronouns used when communicating with that member) given to that participant, while the thickness and shading of a particular arc 810 represents the amount of deference or respect given by one participant to the other participant. Darker and thicker arcs indicate more respect or deference. Of course, the raw data of many of the other categories captured by adjacency matrixes 600 may also be rendered.

The post-processing stage uses knowledge of how to combine the various adjacency matrixes 600 to extract latent, more complex, and often insightful dependencies and inter-relations between the participants of corpus 200. By mathematically combining the quantitative values embedded within adjacency matrixes 600 previously ambiguous or marginally clear relations can be clarified and even latent relations exposed. In a process block 165, select adjacency matrixes 600 are combined in linear or nonlinear manners to generate a combined adjacency matrix. For example, the adjacency matrixes representing the categories of fear, anger, and anxiety may be combined to generate an adjacency matrix measuring a category of general “conflict.” A measure of conflict may be useful to a team leader to better understand who in his team is an instigator or perpetuator of team conflicts. An example of a nonlinear combination of adjacency matrixes is to generate a combined adjacency matrix for measuring social support networks within a group. This combined adjacency matrix uses an exponential combination equation (see Equation 1) to combine the adjacency matrixes counting “number,” “dash,” and “apostrophe” uses within the conversation statements,

Aᵢⱼ=e^{0.358·Number}^{ᵢⱼ}*e^{0.129·Dash}^{ᵢⱼ}*e^{0.219·Apostrophe}^{ᵢⱼ}, (Equation 1)

where e^{x} represents the exponential function and subscripts ‘i’ and ‘j’ represent the position in the adjacency matrixes. The weights for each component conversation link metric are determined by logistic regression with backward selection. Next, a K-short node-disjoint paths algorithm may be used to measure importance based upon both the number and length of disjoint paths between two participants. Weighting decay parameter λ (lambda) is set to 2, and K is set to one less than the actual group size to cover the connectivity of the entire graph. The K-short node-disjoint paths algorithm is described in: White, S. and Smyth, P., Algorithms For Estimating Relative Importance In Networks, Ninth ACM SIGKDD international Conference on Knowledge Discovery and Data Mining (Washington, D.C., Aug. 24-27, 2003). KDD '03. ACM, New York, N.Y., 266-275.

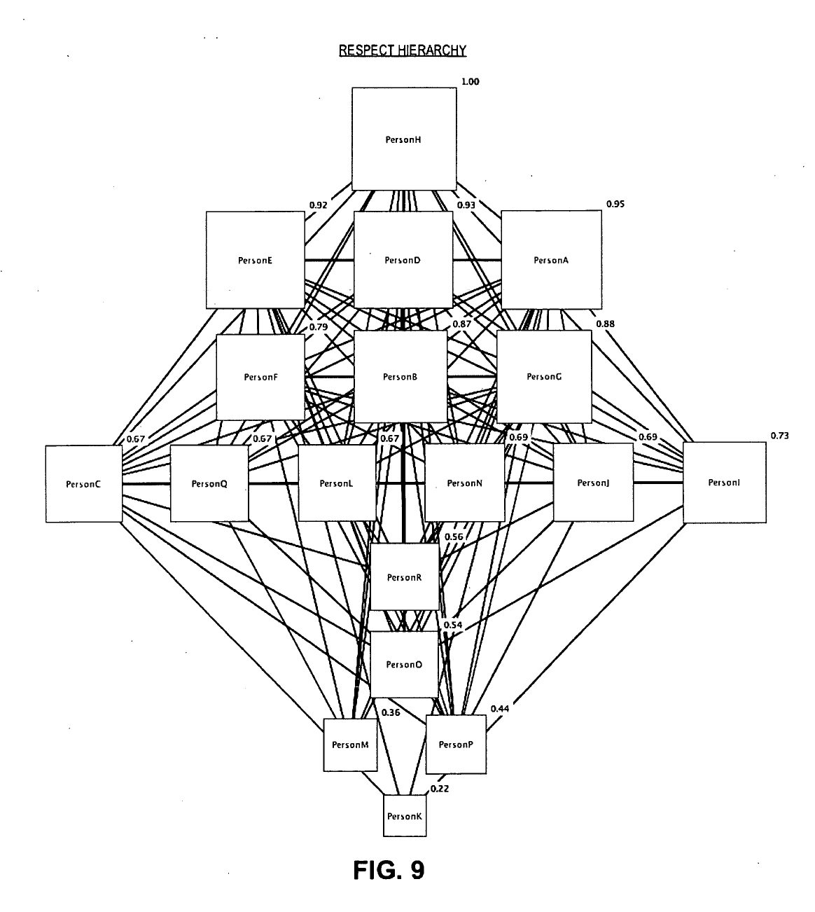

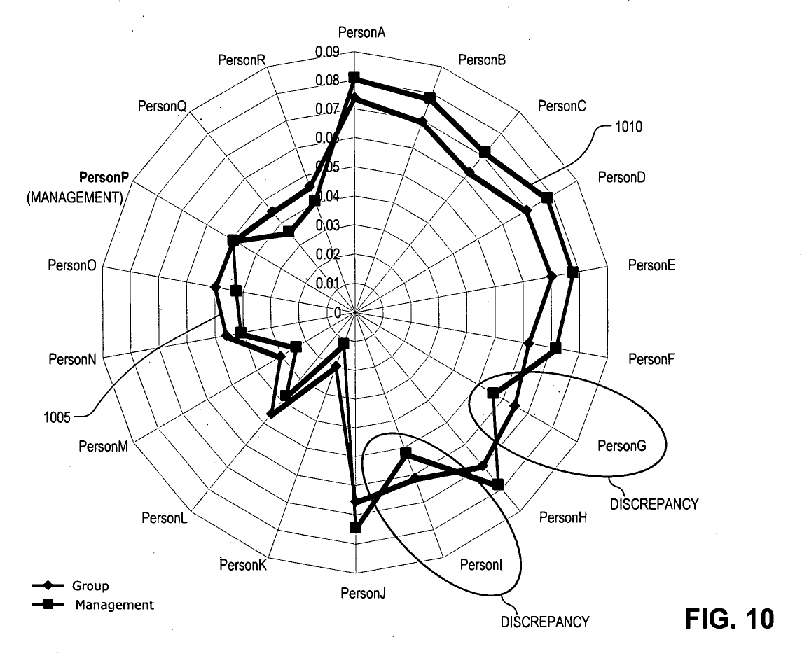

Finally, in a process block 170, the combined adjacency matrixes and the original adjacency matrixes 600 may be input into one or more graph processing algorithms to graphically illustrate the quantitative measures of the participants conversations. For example, a link attribute corresponding to the normalized percentage of personal pronoun (e.g., “me” or “I”) usage strongly correlates with the perceived status of the recipient in the eyes of the source. By using a nodal ranking algorithm (process block 172), individuals in the group can be classified according to the social consensus on their reputation. An example nodal ranking algorithm is Google's PageRank™ calculation. FIG. 9 illustrates a status hierarchy generated by applying the PageRank™ algorithm to the normalized percentage of personal pronoun category. FIG. 10 is another graph generated by applying the PageRank™ algorithm both with and without a prior node set to the personal pronoun link attributes. FIG. 10 is a graph illustrating discrepancies between individual and group defined status. Group line 1005 illustrates the total group perceived status of each member (i.e. without a specified set of nodal priors), while management line 1010 illustrates the status of each individual as perceived by a manager Person P (prior nodal set containing only the manager node). The decay parameter β (beta) was chosen such that Person P is ranked identically under both schemes. As can be seen the manager tends to overvalue some group members, relative to the group defined status, and undervalue other group members, relative to the group defined status. This graph can be used to uncover management biases and perhaps undervalued or overvalued assets within a team.

Similarly, network flow algorithms (process block 174) operating on other link attributes can identify information transmission issues throughout the group. Clustering algorithms (process block 174) can identify cliques and centers of power that may engender conflict due to the psychology of in-group and out-group relations. Various graph processing algorithms may be obtained from the open source project Jung (Java Universal Network/Graph Framework) at http://jung.sourceforge.net; however, other available graph processing algorithms may be used as well. Together, the graph processing algorithms applied to the quantitative link attributes provide a window on how a group is executing its work, both indicating where potential problems lie and informing strategies for improvement.

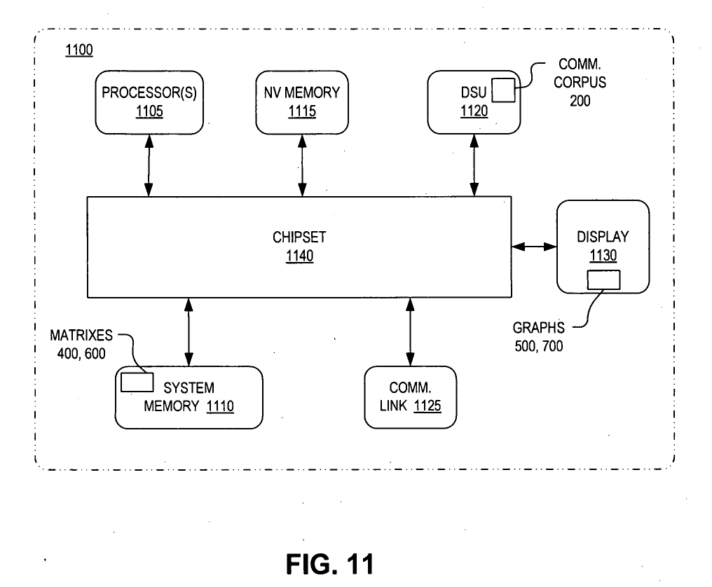

FIG. 11 is a block diagram illustrating a demonstrative processing system 1100 for executing embodiments of the invention described above. The illustrated embodiment of processing system 1100 includes one or more processors (or central processing units) 1105, system memory 1110, nonvolatile (“NV”) memory 1115, a data storage unit (“DSU”) 1120, a communication link 1125, a display 1130, and a chipset 1140. The illustrated processing system 1100 may represent any computing system including a desktop computer, a notebook computer, a workstation, a handheld computer, a server, a blade, or the like. As illustrated, communication corpus 200 may be stored in DSU 1120 while the social network matrix 400 and/or adjacency matrixes 600 may be stored in system memory 1110 during runtime to generate social network graphs 500 and 700 for rendering to display 1130.

The elements of processing system 1100 are interconnected as follows. Processor(s) 1105 is communicatively coupled to system memory 1110, NV memory 1115, DSU 1120, and communication link 1125, via chipset 1140 to send and to receive instructions or data thereto/therefrom. In one embodiment, NV memory 1115 is a flash memory device. In other embodiments, NV memory 1115 includes any one of read only memory (“ROM”), programmable ROM, erasable programmable ROM, electrically erasable programmable ROM, or the like. In one embodiment, system memory 1110 includes random access memory (“RAM”), such as dynamic RAM (“DRAM”), synchronous DRAM (“SDRAM”), double data rate SDRAM (“DDR SDRAM”), static RAM (“SRAM”), or the like. DSU 1120 represents any storage device for software data, applications, and/or operating systems, but will most typically be a nonvolatile storage device. DSU 1120 may optionally include one or more of an integrated drive electronic (“IDE”) hard disk, an enhanced IDE (“EIDE”) hard disk, a redundant array of independent disks (“RAID”), a small computer system interface (“SCSI”) hard disk, and the like. Although DSU 1120 is illustrated as internal to processing system 1100, DSU 1120 may be externally coupled to processing system 1100. Communication link 1125 may couple processing system 1100 to a network such that processing system 1100 may communicate over the network with one or more other computers. Communication link 1125 may include a modem, an Ethernet card, a Gigabit Ethernet card, Universal Serial Bus (“USB”) port, a wireless network interface card, a fiber optic interface, or the like. Display unit 1130 may be coupled to chipset 1140 via a graphics card and renders images for viewing by a user.

It should be appreciated that various other elements of processing system 1100 may have been excluded from FIG. 11 and this discussion for the purposes of clarity. Chipset 1140 may also include a system bus and various other data buses for interconnecting subcomponents, such as a memory controller hub and an input/output (“I/O”) controller hub, as well as, include data buses (e.g., peripheral component interconnect bus) for connecting peripheral devices to chipset 1140. Correspondingly, processing system 1100 may operate without one or more of the elements illustrated. For example, processing system 1100 need not include DSU 1120.

The processes explained above are described in terms of computer software and hardware. The techniques described may constitute machine-executable instructions embodied within a machine (e.g., computer) readable storage medium, that when executed by a machine will cause the machine to perform the operations described. Additionally, the processes may be embodied within hardware, such as an application specific integrated circuit (“ASIC”) or the like.

A machine-readable storage medium includes any mechanism that provides (i.e., stores) information in a form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

1. A computer implemented method for analyzing a communication corpus embodying one or more conversations between participants in the one or more conversations, the method comprising:
generating one or more conversation links for association with conversation statements within the communication corpus, wherein each of the conversation links pairs a source participant who expressed a given conversation statement with a recipient participant to whom the given conversation statement is deemed to have been directed, wherein the conversation links are each unidirectional and each of the conversation links is associated with all conversation statements sharing common FROM and TO attributes;
analyzing, with a computer, the conversation statements to generate conversation link metrics that quantitatively categorize the conversation statements based on at least one of psychological, sociological, or emotional indicia;
inputting the conversation link metrics into a graph processing algorithm executed by the computer; and
rendering a graphical representation of at least one of psychological, sociological, or emotional relationships between the participants to a display coupled with the computer.

2. The method of claim 1, wherein generating the one or more conversation links comprises assigning a “from” attribute and a “to” attribute to each of the conversation statements, the “from” attribute designating the source participant for the given conversation statement and the “to” attribute designating one or more recipient participants for the given conversation statement.

3. The method of claim 2, wherein the communication corpus includes a plurality of emails and the “from” and “to” attributes are determined based on “from” and “to” email addresses embedded within the plurality of emails.

4. The method of claim 2, wherein the communication corpus includes records from a group chat forum, the method further comprising:
segmenting the communication corpus into a plurality of discrete conversations; and
assigning the “to” attribute to only the recipient participants in each of the plurality of discrete conversations.

5. The method of claim 4, wherein segmenting the communication corpus into the plurality of discrete conversations comprises segmenting the communication corpus based at least in part upon whether a threshold time lapse is exceeded between consecutive conversation statements.

6. The method of claim 1, further comprising:
generating a social network matrix identifying the conversation links between the source participants and the recipient participants; and
associating the conversation statements with their corresponding conversation links.

7. The method of claim 1, wherein a first conversation link that associates all conversation statements expressed by a first participant to a second participant is distinct from a second conversation link that associates all conversation statements expressed by the second participant to the first participant.

8. The method of claim 6, further comprising rendering a social network graph based on the social network matrix, the social network graph including:
a plurality of nodes each representing one of the participants in the one or more conversations embodied within the communication corpus; and
arcs linking the nodes, each of the arcs representing one of the conversation links.

9. The method of claim 8, wherein the social network graph further including a loop arc initiating and terminating on a single node, the loop arc representing one of the conversation links where the source participant expressed one of the conversation statements that was not responded to.

10. The method of claim 1, further comprising:
generating adjacency matrixes in response to analyzing the conversation statements; and
populating each of the adjacency matrixes with conversation link metrics of a given category.

11. The method of claim 10, further comprising combining the conversation link metrics from different adjacency matrixes into a combined adjacency matrix.

12. The method of claim 11, wherein combining the conversation link metrics comprises a linear combination of the conversation link metrics.

13. The method of claim 11, wherein combining the conversation link metrics comprises a nonlinear combination of the conversation link metrics.

14. The method of claim 11, wherein the different adjacency matrixes are selected for combination into the combined adjacency matrix based at least in part upon a correlation between at least one of a psychological, sociological, or emotional category associated with each of the selected different adjacency matrixes and a particular social structure or process into which insight is desired.

15. The method of claim 1, wherein analyzing the conversation statements to generate the conversation metrics comprises quantifying instances of at least one of psychological, sociological, or emotional indicia within each of the conversation statements to generate the conversation link metrics.

16. The method of claim 15, wherein analyzing the conversation statements comprises:
combining all conversation statements associated with a particular conversation link into a document; and
generating indicia counts or indicia ratios based on the document.

17. The method of claim 15, wherein analyzing the conversation statements comprises:
generating indicia counts or indicia ratios for each of the conversation statements associated with a given conversation link; and
averaging the indicia counts or indicia ratios over all the conversation statements associated with the given conversation link.

18. The method of claim 15, wherein the at least one of psychological, sociological, or emotional indicia are deterministic indicators.

19. The method of claim 1, wherein analyzing the conversation statements to generate the conversation link metrics comprises latent semantic analysis of the conversation statements to generate statistical correlations between the conversation statements and at least one of psychological, sociological, or emotional categories of interest.

20. The method of claim 1, wherein the graphing algorithm comprises a nodal ranking algorithm that identifies a hierarchy of respect between the participants based on the communication metrics.

21. The method of claim 20, wherein the nodal ranking algorithm identifies discrepancies between group respect for the participants and individual respect for the participants.

22. The method of claim 1, wherein the graphing algorithm comprises a network flow algorithm that identifies social support networks between the participants based on the communication metrics.

23. The method of claim 1, wherein the graphing algorithm comprises a clustering algorithm that identifies cliques within the participants based on the conversation link metrics.

24. A computer-readable storage medium that provides instruction, that when executed by a computer, will cause the computer to perform operations comprising:
inspecting a communication corpus of conversation statements between participants to one or more conversations;
generating one or more conversation links for association with the conversation statements, wherein each of the conversation links pairs a source participant who expressed a given conversation statement with a recipient participant to whom the given conversation statement is deemed to have been directed, wherein the conversation links are each unidirectional and each of the conversation links is associated with all conversation statements sharing common FROM and TO attributes;
analyzing the conversation statements to generate conversation link metrics that quantitatively categorize the conversation statements based on at least one of psychological, sociological, or emotional indicia; and
generating at least one adjacency matrix including the conversation link metrics associated with each pair of source and recipient participants sharing a common conversation link,
wherein a first conversation link that associates all conversation statements expressed by a first participant to a second participant is distinct from a second conversation link that associates all conversation statements expressed by the second participant to the first participant.

25. The computer-readable storage medium of claim 24, further providing instructions that, when executed by the computer, will cause the computer to perform further operations, comprising:
inputting the conversation metrics into a graphing algorithm; and
rendering a graphical representation of at least one of psychological, sociological, or emotional relationships between the participants.

26. The computer-readable storage medium of claim 24, further providing instructions that, when executed by the computer, will cause the computer to perform further operations, comprising:
generating a social network matrix identifying the conversation links between the source participants and the recipient participants; and
associating the conversation links with their corresponding conversation statement.

27. The computer-readable storage medium of claim 26, further providing instructions that, when executed by the computer, will cause the computer to perform further operations, comprising:
rendering a social network graph based on the social network matrix, the social network graph including:
a plurality of nodes each corresponding to one of the participants to the one or more conversations embodied within the communication corpus; and
arcs linking the nodes, each of the arcs representing one of the conversation links.

28. The computer-readable storage medium of claim 24, wherein generating the one or more conversation links comprises assigning a “from” attribute and a “to” attribute to each of the conversation statements, the “from” attribute designating the source participant for the given conversation statement and the “to” attribute designating one or more recipient participants for the given conversation statement.

29. The computer-readable storage medium of claim 28, wherein the communication corpus includes records from a group chat forum, the method further comprising:
segmenting the communication corpus into a plurality of conversations; and
assigning the “to” attribute to only the recipient participants of each of the plurality of conversations.

30. The computer-readable storage medium of claim 29, wherein segmenting the communication corpus into the plurality of conversations comprises segmenting the communication corpus based at least in part upon whether a threshold time lapse is exceeded between consecutive conversation statements.

31. The computer-readable storage medium of claim 25, wherein the graphing algorithm comprises an algorithm selected from a group consisting of:
a first nodal ranking algorithm that identifies a hierarchy of respect between the participants based on the communication metrics,
a second nodal ranking algorithm that identifies discrepancies between group respect for the participants and individual respect for the participants,
a network flow algorithm that identifies social support networks between the participants based on the communication metrics, and
a clustering algorithm that identifies cliques within the participants based on the communication metrics.

32. The computer-readable storage medium of claim 24, further providing instructions that, when executed by the computer, will cause the computer to perform further operations, comprising:
generating a plurality of adjacency matrixes in response to analyzing the conversation statements;
populating each of the adjacency matrixes with conversation link metrics of a given category; and
combining the conversation link metrics from different adjacency matrixes into a combined adjacency matrix.
